(19) United States
(12) Patent Application Publication
(10) Pub. No.: US 2002/0033558 A1
(43) Pub. Date: Mar. 21, 2002

(54) UV laser cutting or shape modification of brittle, high melting temperature target materials such as ceramics or glasses

(76) Inventors: Kevin P. Fahey, Portland, OR (US); Michael J. Wolfe, Portland, OR (US)

Correspondence Address: STOEL RIVES LLP, 900 SW FIFTH AVENUE, SUITE 2600, PORTLAND, OR, 97204, US

(21) Appl. No.: 09/803,382

(22) Filed: Mar. 9, 2001

Related U.S. Application Data
(60) Provisional application No. 60/233,913, filed on Sep. 20, 2000.

(51) Int. Cl. B29C 35/08

(52) U.S. Cl. 264/400

(57) ABSTRACT

A UV laser (102) cuts ceramics or glasses such as the alumina or ceramic of sliders (10), and particularly separates rows (60) or sliders (10) or rounds edges (66, 82, 86). A preferred process entails covering the surfaces of wafers (50), rows (60), or sliders (10) with a sacrificial layer; removing a portion of the sacrificial layer to create uncovered zones along existing edges or over intended edges; laser cutting wafers (50) into rows (60) or rows (60) into sliders (50); laser rounding edges (66, 68, 82, 84, and/or 86), and/or corners (85 and/or 87); cleaning debris from the uncovered zones; and removing the sacrificial layer. Although a preferred laser is a Q-switched, UV solid-state laser (100) providing imaged and/or shaped output at a bite size of between about 1 to 7 μm, other lasers including excimers can be employed.

This patent application derives priority from U.S. Provisional Application No. 60/233,913, filed Sep. 20, 2000.

### TECHNICAL FIELD

The invention relates to laser material processing and, in particular, to employing an ultraviolet laser output to round comers or edges of workpieces such as sliders, recording heads or target materials such as alumina or alumina/titanium carbide.

### BACKGROUND OF THE INVENTION

Sliders move from track to track of direct access storage devices (DASD), such as disk drives including rotatable magnetic recording disks, to read or record desired information on the tracks. FIG. 1 is a deposited end perspective view of a trailing edge 12 of a prior art slider 10, and FIG. 2 is a cross-sectional view of trailing edge 12 of slider 10 with its magnetic head 14 oriented toward a magnetic recording disk 20. The figures accompanying this description are generally not drawn to scale or in proportion. For example, in FIGS. 1 and 2, the components of slider 10 are not drawn to scale or in proportion. A conventional “pico” slider 10 may have a slider height, hₛ, of about 300 microns (μm), a slider width, wₛ, of about 1000 μm, and a slider depth or length, lₛ, of about 1250 μm.

With reference to FIGS. 1 and 2, a typical slider 10 includes a non-magnetic substrate 22 typically made of a ceramic material. Substrate 22 typically has a substrate depth, dₛ, of about 300 μm deep and forms a majority of the body of slider 10. Substrate 22 generally, therefore, defines an air-bearing surface (ABS) 24 having an aerodynamic configuration suitable for lifting slider 10 a desired distance above the surface of disk 20 as it rotates. Transducer or magnetic head 14 has first and second spaced-apart magnetic pole pieces 28 and 30 which are located in proximity to trailing edge 12 of slider 10. Magnetic pole pieces 28 and 30 include first and second pole tips 32 and 34 that are aligned with the air-bearing surface 24. A non-magnetic gap layer 36 is located between the first and second pole pieces 28 and 30. Additionally, an insulating layer 38 is positioned between the non-magnetic layer 36 and the second magnetic pole piece 30. The insulating layer 38 is typically made of a polymeric material such as hard-baked photoresist, and a coil 40 is located within insulating layer 38. Finally, an overcoat layer 42, typically comprising 20-50 microns of a vacuum-deposited alumina (Al₂O₃), covers magnetic head 14 and forms trailing edge 12 of slider 10.

FIGS. 3-5 illustrate various steps or stages of a method for manufacturing typical sliders 10. FIG. 3 shows a deposited end view of a ceramic wafer 50 supporting a plurality of sliders 10. The various layers of each slider 10 are built up layer by layer upon the wafer 50 to form the previously described slider features by deposition processes known to the semiconductor industry. An exemplary technique for generating the layers of a slider having a thin-film magnetic head is described in U.S. Pat. No. 4,652,954.

Wafer 50 is then typically cut into sections and then sliced into rows 60 along straight slicing lanes 62 by a mechanical cutting blade to form coarse air-bearing surfaces 24 and generally parallel nonair-bearing surfaces 64. The mechanical cutting process creates sharp edges 66 and 68 (FIGS. 1 and 2) with small chips along slicing lanes 62. Conventional slicing blades typically have a narrow dimension of about 200-300 μm along their cutting axis and produce cuts that are wider than the blades. The slicing blades currently need to be this wide to withstand stresses of making straight cuts through the strength and thickness of conventional slider wafers 50, for example. Thus, the lane width, wₗ, between rows 60 of sliders 10 is greater than cut width to accommodate cut width variations due to blade wear and misalignments. Hence, the row pitch equals wₗ, plus hₛ, and the maximum number of rows equals the usable wafer diameter, d_{w}, divided by the row pitch. A conventional row pitch is, for example, 600 μm.

Course air-bearing surfaces 24 formed in the wafer slicing process are polished using advanced but cumbersome and time-consuming lapping techniques and slurries. Rows 60 are mounted on a fixture or carrier 70 after ABS polishing so that multiple rows 60 can simultaneously be processed through subsequent steps. The mounting procedure must employ an adhesive between nonair-bearing surfaces 64 and carrier 70 that is selected for sufficient mechanical strength to withstand the stresses of a later step of mechanically dicing the rows 60 into individual sliders 10. Unfortunately, these adhesives make it difficult to debond sliders 10 from carrier 70 at a later time.

FIG. 4 illustrates rows 60 of sliders 10 mounted on carrier 70 and oriented so that the air-bearing surfaces 24 of magnetic heads 14 are facing upwards. With reference to FIG. 4, polished air-bearing surfaces 24 are covered by photoresist pattern masks 72 that correspond with a desired air-bearing surface configuration having aerodynamic characteristics suitable for causing heads 14 to fly a desired level above disks 20. Photoresist masks are formed by first coating the entire surface with photoresist. Then, a masking tool having a predetermined pattern is aligned relative to the pole tips 32 and 34 or other fiducials, and light is directed through the masking tool so that selected portions of the photoresist on the polished ABSs 24 are exposed. Alignment of the masking tool is achieved by using a stepper with row-bar alignment or a well-aligned contact/projected aligner. After exposure, the photoresist is developed such that the desired air-bearing surface configurations are left covered with the photoresist masks 72, while the remainder of the photoresist is removed.

Once rows 60 of sliders 10 have been masked with the desired pattern of photoresist, the polished ABSs are etched by etching techniques such as ion milling or reactive ion etching which are expensive and slow. Such etching techniques etch away the exposed regions 74 of surfaces 24 to a desired depth to form raised covered regions or rails 76 underlying masks 72. The photoresist mask 72 is finally stripped away to reveal the desired patterns on the air-bearing sides of sliders 10.

With reference again to FIG. 4, rows 60 are diced by mechanical dicing blade along straight dicing singulation or paths 78 to create edges 82. The dicing blades for this cutting operation have a narrow dimension of about 75-150 μm along their cutting axis and produce cuts of about 150 μm wide. Thus, the path width, wₚ, between rows 60 of sliders 10 is slightly greater. Hence, the slider pitch equals wₚ plus wₛ, and the maximum number of sliders 10 per row 60 equals the row length (or usable wafer diameter) divided by the slider pitch. A conventional slider pitch is, for example, 1150 μm for a 100 μm wide dicing path. The dicing process creates small chips as it creates sharp edges 82, 84, and 86 and sharp corners 85 and 87 (FIG. 1) along singulation paths 78.

FIG. 5 also shows carrier 70 supporting a number of rows 60a, 60b, 60c, and 60d (generically rows 60) prior to dicing into individual sliders 10 with sides 80. Although row 60a depicts a typical row 60, rows 60b, 60c, and 60d demonstrate common slider manufacturing problems. Row 60b is relatively straight but is fixed to carrier 70 such that it is askew to row 60a. Row 60c is also relatively straight and relatively parallel to row 60a, but the pole tips 32 and 34 and/or the rails 76 of row 60c are offset with respect to those in row 60a. Row 60d exhibits row bow that may be primarily caused by stresses resulting from the mechanical slicing of wafer 50 into rows 60.

Because the dicing blade must cut along straight singulation paths 78, the sides 80 of sliders 10 in any column must be aligned within about one-half of the remainder of the path width minus the cut width. In view of the foregoing, rows 60b, 60c , and 60d can create a problem for the mechanical dicing operation and may reduce yield of sliders 10 with acceptable magnetic or aerodynamic properties. If the slant of row 60b is significant, the edges 82 of sliders in row 60b are askew with respect to rails 76, and the sliders 10 in row 60b will be defective. Similarly, many of sliders 10 in bowed row 60d, especially those at the ends for the case depicted, will be defective depending on the significance and position of the curves. With respect to row 60c, if the ABS features are sufficiently offset with respect to the other rows 60, then all sliders in row 60c will be defective since the edges of the sliders will be in improper positions or the dice paths will cut into ABS features.

The above-described process for manufacturing sliders 10 has several other drawbacks. In particular, sharp edges 66, 68, 82, 84, and 86, sharp corners 85 and 87, and chips formed during the dicing process make sliders 10 more susceptible to damage. For example, external shocks, such as by dropping a disk drive on the floor, can cause the sharp corners of the slider 10 to cut into the disk media, can cause cracks to propagate, or can cause particles to break loose at chipped locations which can then interfere with the ability of head 14 to make proper contact with disk 20. Polishing steps, which are time-consuming and employ expensive reagents, do not generally eliminate these chips or sharp edges.

In addition, the wide cuts made by the mechanical cutting blades significantly reduce the number of rows 60 and sliders 10 that can be fit onto each wafer 50. Skilled persons will also note that dicing blades tend to wear relatively quickly such that the width of their cuts may vary over time. In some cases, the blades can be inadvertently bent and then they produce curved or slanted cuts or increased chipping.

U.S. Pat. Nos. 5,872,684 of Hadfield et al. ('684 Patent) describes a method for etching a portion 88 of overcoat layer 42 wherein the etched portion 88 extends between the second pole tip 34 and trailing end 12 of slider 10. Etched portion 88 is sloped with respect to air-bearing surface 24 of slider 10 and is arranged and configured for preventing the overcoat layer from protruding past the air-bearing surface upon expansion of overcoat layer 42 during operation of magnetic head 14. Otherwise, overcoat layer 14 could form a protruding portion 90 due to localized heating when coil 40 is subjected to write currents and could interfere with slider/disk contact. Photolithography masking and etching techniques, like those described above, are used to etch away the potential protrusion regions of alumina overcoat layer 42. The '684 Patent does not address the dicing-generated chips or other dicing-related reliability problems.

A better method for manufacturing sliders 10 is therefore desirable.

### SUMMARY OF THE INVENTION

An object of the present invention is, therefore, to provide a better method and/or system for laser processing brittle, high melting temperature materials such as ceramics or glasses or particularly alumina or AlTiC.

One embodiment of the invention provides such a method or system that facilitates the manufacturing of sliders.

Another embodiment of the invention provides such a method or system that eliminates the cutting-formed sharp edges and chips on either the front or back sides of ceramic, glass, or silicon sliders or dies during the manufacturing process.

Another embodiment of the invention provides such a method or system that decreases the widths of the cutting lanes or paths between the rows and sliders.

Attempts may have been made to use infrared (IR) lasers to machine alumina or alumina/titanium carbide (Al₂O₃/TiC) mixtures (also commonly referred to as AlTiC). IR wavelengths to a limited extent have been shown to machine the mixtures, but tend to damage pure alumina such as by unpredictably cracking the layer and by throwing permanent redeposited material (redep), such as melted slag, onto the top surface of the slider and by creating a “melt lip” where the edge of the cut pulls backward and up.

U.S. Pat. Nos. 5,593,606 and 5,841,099 of Owen et al. describe techniques and advantages for employing UV laser systems to generate laser output pulses within advantageous parameters to form through-hole or blind vias through at least two different types of layers in multilayer devices. These parameters generally include nonexcimer output pulses having temporal pulse widths of shorter than 100 ns, spot areas with spot diameters of less than 100 μm, and average intensities or irradiances of greater than 100 mW over the spot areas at repetition rates of greater than 200 Hz.

Despite the foregoing, solid-state UV lasers have not been employed successfully to machine sliders and particularly have not been employed successfully to machine brittle, high melting temperature ceramic, glass, or glass-like materials such as alumina or alumina/titanium carbide (Al₂O₃/TiC, also known as AlTiC) in the context of sliders.

Accordingly, one embodiment of the present invention employs a UV laser to cut ceramics, glasses, or silicon which may comprise the body of sliders 10, and particularly separate rows 60 or sliders 10 or round edges. A preferred process entails covering the surfaces of wafers 50, rows 60, or sliders 10 with a sacrificial layer such as photoresist; removing a portion of the sacrificial layer to create uncovered zones along existing edges or over intended edges; laser cutting wafers 50 into rows 60 or rows 60 into sliders 50; laser rounding edges 66, 68, 82, 84, and/or 86, and/or corners 85 and/or 87; cleaning debris form the uncovered zones such as by ion milling; and removing the sacrificial layer. Another process sequence includes an initial notching of the air-bearing surface 24 to form kerfs between rows 60 or sliders 10; laser processing to round the edges of the corners formed during the notching; and a final cutting to separate the rows or singulate the sliders.

Although a preferred laser is a UV Q-switched, solid-state laser providing imaged, shaped output at a bite size of between about 1 to 7 μm, other UV lasers including excimers can be employed.

Additional objects and advantages of this invention will be apparent from the following detailed description of preferred embodiments thereof which proceeds with reference to the accompanying drawings.

### BRIEF DESCRIPTION OF THE DRAWINGS

FIG. 1 is a deposited end perspective view of a prior art slider including a magnetic recording head.

FIG. 2 is an enlarged cross-sectional view of a trailing end of a slider with its head oriented toward a magnetic recording disk.

FIG. 3 is a plan view of a wafer having a plurality of thin-film magnetic heads, such as the magnetic head shown in FIG. 2, deposited thereon.

FIG. 4 is a plan view of a carrier supporting diced into rows of sliders from the wafer of FIG., the air-bearing surface of the sliders being patterned with a photoresist mask.

FIG. 5 is a simplified plan view of a carrier supporting a number of slider rows, some of which exhibit row defects including misalignment, prior to dicing into individual sliders.

FIG. 6 is a simplified and partly schematic view of an embodiment of a laser system employed for processing workpieces in accordance with the invention.

FIG. 7 is an enlarged bottom view of a slider undergoing laser processing along a trim path.

FIG. 8 is a deposited end perspective view of a slider processed in accordance with one embodiment of the invention.

FIG. 9 is a deposited end perspective view of a slider processed in accordance with another embodiment of the invention.

FIG. 9A is a deposited and perspective view of a slider processed in accordance with yet another embodiment of the invention.

FIGS. 10a-10h are simplified side sectional views of a generic workpiece as it undergoes process steps of an exemplary laser rounding process.

FIGS. 11a-11f are simplified side sectional views of a generic workpiece as it undergoes process steps of an exemplary laser cutting process.

FIG. 12 is a simplified side section view of a generic workpiece undergoing a number of lines or rows of laser passes whose positions vary with distance from an edge.

FIG. 13 is a plan view of a portion of a row carrier supporting bowed and angled slider rows that can be diced by laser row defect compensation.

FIG. 14 shows a flow diagram of notching, rounding, and separating process with simplified side sectional views of a generic workpiece as it undergoes process steps.

FIG. 15 shows a flow diagram of a rounding and separating process.

FIG. 16 shows a flow diagram of an alternative rounding and separating process.

FIG. 17 shows examples of excimer mask lines used for resist removal, edge rounding, slicing, or dicing.

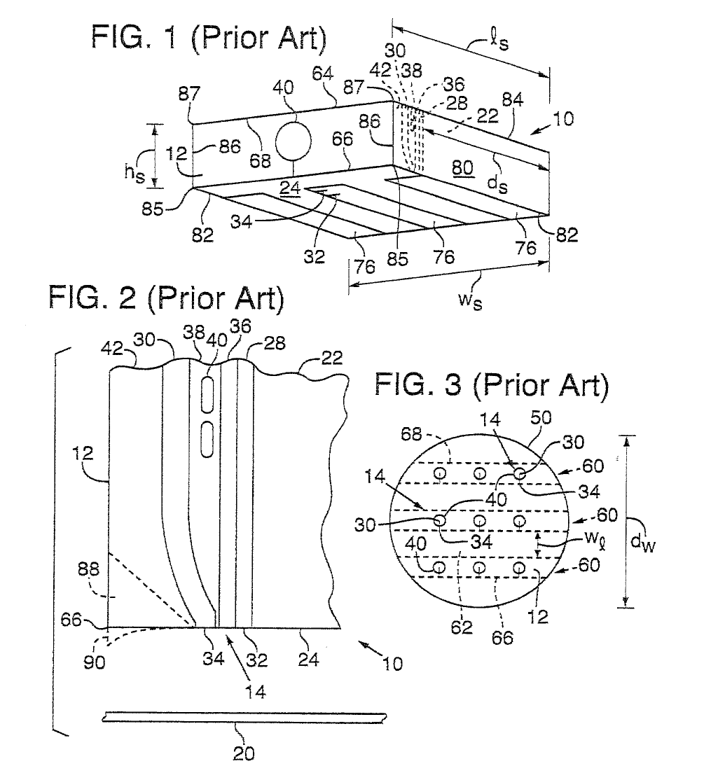

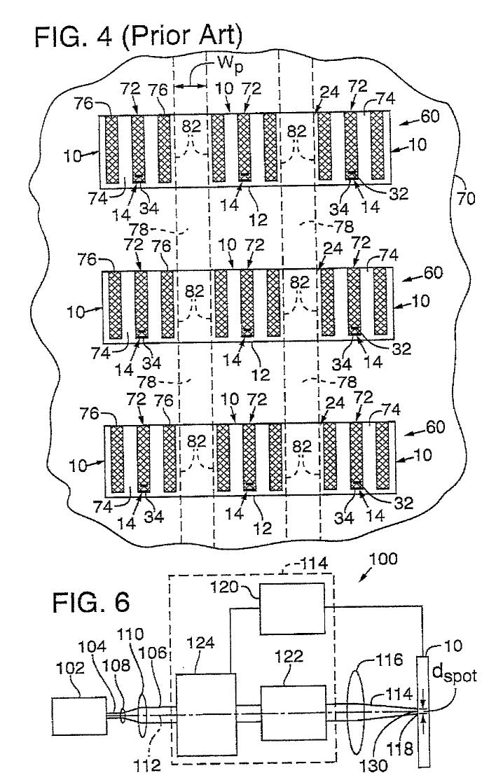

### DETAILED DESCRIPTION OF PREFERRED EMBODIMENT

With reference to FIG. 6, a preferred embodiment of a laser system 100 of the present invention includes Q-switched, diode-pumped (DP), solid-state (SS) UV laser 102 that preferably includes a solid-state lasant such as Nd:YAG, Nd:YLF, Nd:YAP, or Nd:YVO₄, or a YAG crystal doped with holmium or erbium. Laser 102 preferably provides harmonically generated UV laser output 130 of one or more laser pulses at a wavelength such as 355 nm (frequency tripled Nd:YAG), 266 nm (frequency quadrupled Nd:YAG), or 213 nm (frequency quintupled Nd:YAG) with primarily a TEM₀₀ spatial mode profile.

Skilled persons will appreciate that other wavelengths are available from the other listed lasants. Laser cavity arrangements, harmonic generation, and Q-switch operation are all well known to persons skilled in the art. Details of one exemplary laser 102 are described in detail in U.S. Pat. No. 5,593,606 of Owen et al.

UV laser pulses 104 may be converted to expanded collimated pulses or output 106 by a variety of well-known optics including beam expander or upcollimator lens components 108 and 110 (with, for example, a 2× beam expansion factor) that are positioned along beam path 112. Collimated pulses 106 are directed by a beam positioning system 114 and through an objective scan or cutting lens 116 to a desired laser target position 118, such as edges 66, 68, 82, 84, and 86 of a workpiece such as slider 10.

Beam positioning system 114 preferably includes a translation stage positioner 120 and a fast positioner 122. Translation stage positioner 120 employs at least two platforms or stages that support, for example, X, Y, and Z positioning mirrors and permit quick movement between target positions 118 on the same or different edges of the same or different slider 10. In a preferred embodiment, translation stage positioner 120 is a split-axis system where a Y stage, typically moved by linear motors, supports and moves slider 10, an X stage supports and moves fast positioner 122 and objective lens 116, the Z dimension between the X and Y stages is adjustable, and fold mirrors 124 align the beam path 64 through any turns between laser 102 and fast positioner 122. Fast positioner 122 may for example employ high resolution linear motors or a pair of galvanometer mirrors that can effect unique or duplicative processing operations based on provided test or design data. These positioners can be moved independently or coordinated to move together in response to panelized or unpanelized data.

Such a preferred beam positioning system 114 that can be used for present application is described in detail in U.S. Pat. No. 5,751,585 of Cutler et al. Other preferred positioning systems such as a Model series numbers 27xx, 43xx, 44xx, or 53xx, manufactured by Electro Scientific Industries, Inc. in Portland, Oreg., can also be employed. Some of these systems which use an X-Y linear motor for moving the workpiece and an X-Y stage for moving the scan lens are cost effective positioning systems for making long straight cuts. Skilled persons will also appreciate that a system with a single X-Y stage for workpiece positioning with a fixed beam position and/or stationary galvanometer for beam positioning may alternatively be employed.

A laser controller (not shown) that directs the movement of the beam positioning components preferably synchronizes the firing of laser 102 to the motion of the components of beam positioning system 114 such as described in U.S. Pat. No. 5,453,594 of Konecny for Radiation Beam Position and Emission Coordination System. An example of a preferred laser system 100 that contains many of the above-described system components employs a Model (ESI model # for LWE 210-3500) or other in its series high-power UV laser (266 or 355 nm) sold by Electro Scientific Industries, Inc. in Portland, Oreg.

Beam positioning system 114 can employ conventional vision or beam to work alignment systems that work through objective lens 116 or off axis with a separate camera and that are well known to skilled practitioners. In one embodiment, an HRVX vision box employing Freedom Library software in a positioning system 114 manufactured by Electro Scientific Industries, Inc. is employed to perform alignment between the laser system and the target locations on the workpiece. Other suitable alignment systems are commercially available. The alignment systems preferably employ bright-field, on-axis illumination, particularly for specularly reflecting workpieces like lapped or polished sliders 10.

For laser cutting (row slicing separation or slider dicing singulation), cutting and rounding, or notching, rounding, and cutting applications, the beam positioning system 114 is preferably aligned to pole tips 32 and 34, fiducials such as sensors or conventional saw cutting fiducials, or the pattern on the air-bearing surface 24 such as the pattern of exposed regions 74 or rails 76. If the sliders 10 are already mechanically cut or notched, alignment to the cut edges 82, 84, or 86 is preferred to overcome the saw tolerance and alignment errors. Beam positioning system 114 preferably has alignment accuracy of better than about 3-5 μm, such that the center of the laser spot is within about 3-5 μm of edges 82, 84, or 86, particularly for laser beam spot sizes such as 10-15 μm. For smaller spot sizes, the alignment accuracy may preferably be even better. For larger spot sizes or for laser cutting operations, the accuracy can be less precise.

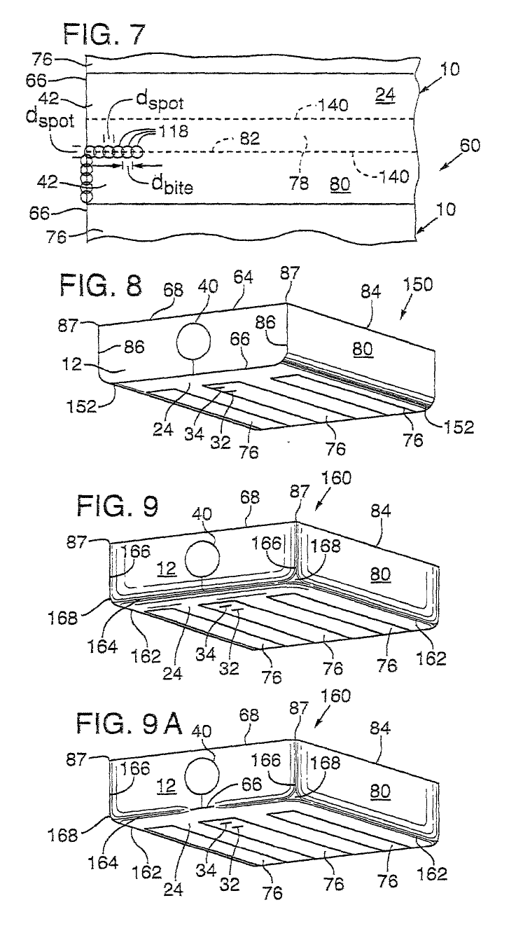

FIG. 7 is an enlarged bottom view of slider 10 undergoing laser processing along a trim line 140. With reference to FIG. 7, laser output 130 is directed along one or more trim lines 140 positioned between sliders 10 or between rows 60. Laser output 130 preferably produces a spot size dₛₚₒₜ at target position 118 on slider 10 (or row 60 or wafer 50). Laser output 130 is preferably applied so that only one pulse impinges each target position 118 along trim line 140 before moving to a subsequent target position 118. Where the desirable depth of material to be processed warrants multiple impingements at each target position 118 along trim line 140, multiple distinct passes can be employed to eventually singulate sliders 10 or sever rows 60. Although spot size and the spacing of the dₛₚₒₜ can refer to 1/e² points, especially with respect to the description of the laser system, these terms are more generally used to refer to the diameter of the hole created by a single pulse or the width of a kerf created in a single pass of pulses. For the materials of interest, these kerf sizes are typically 1.5-3 times larger than the spacing of the 1/e² points. The kerf widths that result from multiple passes are typically even larger.

The distance of new target material impinged by each sequential laser pulse is called the bite size d_{bite}. A preferred laser processing window for laser processing slider 10, particularly for processing brittle, high melting temperature materials such as glass-like or ceramic materials including alumina, AlTiC, titanium carbide, or silicon carbide, includes selection of a particular bite size range. Unlike most conventional processing window selection or determination techniques that begin with the selection of pulse energy and spot size, the processing window selection in accordance with the present invention begins with the selection of bite size d_{bite}. A bite size d_{bite} that is too small will cause undesirable cracks in slider 10, and a bite size d_{bite} that is too large will cause melting. Undesirable cracks can cause greater damage susceptibility, and melting can create lips or generate permanent redep, such as that generated during IR laser cutting, that cannot be removed by benign conventional cleaning techniques. A preferred bite size d_{bite} for laser processing of slider 10 in accordance with the present invention includes a range of about 0.5-9.5 μm, and more preferably a range of about 1-7 μm, and most preferably a range of about 2.5-5.5 μm. The preferred bite size results in a condition where the redep debris generated is generally not molten, does not permanently reattach itself to workpiece surfaces such as ABS 24, and can be cleaned off by benign conventional processes. UV laser processing at too large a bite size such as greater than about 79.5 μm or at too low an energy such as less than about 100-150 μJ per pulse (at 266 nm and 5 kHz) tends to create permanent redep that cannot be easily removed from ABS surface 24. The bite size can be adjusted by controlling the speed of either or both of the stages of the positioning system 114 and coordinating the movement speed(s) with the repetition rate and firing of the laser.

Other preferred parameters for laser system output 130 may include spot area or spot size diameters or spatial major axes of about 5 μm to greater than 300 μm, preferably from about 5-25 μm, and most preferably from about 8-15 μm, particularly 12 μm; average power densities of about 100-300 μJ per pulse or higher, preferably at least about 200 μJ per pulse; a peak power density of greater than 500 megawatts (MW) per cm²; a repetition rate of about 1-30 kHz, preferably of about 5-15 kHz; an ultraviolet wavelength, preferably between about 180-360 nm, and most preferably shorter than or equal to about 355 nm and particularly 266 nm; and temporal pulse widths that are shorter than about 100 ns, and preferably from about 15-70 ns or shorter. Minimum desirable power density for 355 nm pulses is about 400-600 μJ, and the minimum desirable power density for 266 nm pulses is about 150-250 μJ. Skilled persons will also appreciate that a larger processing window than the above-described processing parameters can be employed for non-slider rounding applications. The preferred parameters are selected to maintain the pristine grain structure (no significant evidence of melting) of the AlTiC up to the edge of the cut and ensure that any debris landing on the workpiece surface can be cleaned off.

Although a beam spot having a traditional Gaussian irradiance profile may be employed, a clipped-Gaussian imaging irradiance profile that clips or reduces the “wings” or “tails” of the Gaussian beam spot can also be employed. In addition, an imaged shaped Gaussian beam can be employed to provide a beam spot with substantially uniform “tophat” irradiance profile. In one embodiment of the invention, a UV DPSS laser system is equipped with a diffractive optical element (DOE) to shape the raw laser Gaussian irradiance profile into a “top hat” or predominantly substantially uniform irradiance profile. The resulting shaped laser output is then clipped by an aperture or mask to provide an imaged shaped output beam. This technique is described in detail in International Publication No. WO 00/73103 published on Dec. 7, 2000. The relevant portions of the disclosure of corresponding U.S. patent application Ser. No. 09/580,396 of Dunsky et al., filed May 26, 2000 are herein incorporated by reference. Alternatively, the shaped laser output can be employed without using an aperture.

Employing a clipped or imaged shaped Gaussian beam facilitates more precise corner rounding and singulation. In addition to facilitating greater spot shape control and consistency and depth control (particularly for imaged shaped), beam spots with minimized tails generate redep debris that are more easily cleaned by nonaggressive cleaning techniques than redep debris generated by unmodified Gaussian beam spots.

FIGS. 8 and 9 are exemplary deposited end perspective views of alternative slider embodiments after processing in accordance with the invention as described herein. With reference to FIGS. 8 and 9, processed slider 150 exhibits rounded edges 152 where edges 82 have been processed by laser system output 130, and processed slider 160 exhibits rounded edges 162, 164, and 166 where edges 82, 66, and 86 have been processed by laser system output 130. Processed slider 160 also exhibits rounded corners 168 even when corners 85 have not been separately and intentionally processed by laser system output 130. Separately and intentionally processing corners 85 provides, however, a greater radius of curvature. Skilled persons will appreciate that upper edges 68 and/or 84 and/or upper corners 87 can also be rounded by laser system output 130 if desirable. Sliders 150 and 160 are less susceptible to external shocks or chip generation than sliders 10, and sliders 150 and 160 can also ride closer to and make proper contact with disk 20.

FIG. 9A shows a variation of FIG. 9. With reference to FIG. 9A, a selected portion of edge 66 in proximity tip 169 is not rounded. In general, selected portions of any edge can be left unrounded whenever it is beneficial to do so. The positioning system 114 can simply be instructed to pass over such portions.

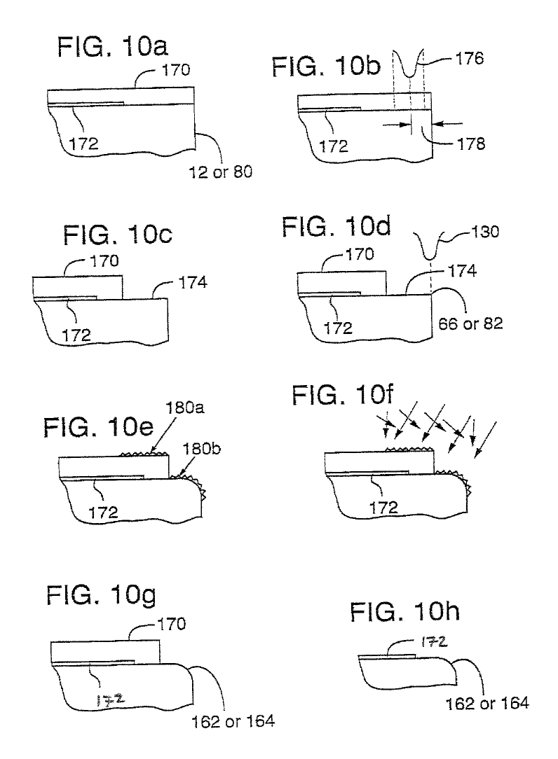

FIGS. 10a-10h (collectively FIG. 10) show simplified side sectional views of a generic workpiece as it undergoes process steps of an exemplary laser rounding process. In one embodiment, a mechanical cutting blade separates rows 60 or sliders 10 along lanes 62 or paths 78 to form surfaces 24 or sides 80, respectively. The respective edges 66 and/or 82 can then be rounded with laser system output 130. An advantage of this technique is that it suits the established infrastructure in the industry. Another advantage of mechanically cutting lanes 62 or paths 78 first is that there is no debris surrounding the cut so mechanical cutting provides the laser rounding operation with a flat surface that facilitates rounding the edges to a preferred radius of curvature.

With reference to FIG. 10a, an optional sacrificial protection layer 170 may be applied to patterned ABS 24 or all of the workpiece surfaces prior to laser rounding to protect ABS surface 24 and important ABS features 172, including rails 76 and pole tips 32 and 34, from redep and/or to facilitate cleaning of nonpermanent redep. A preferred sacrificial layer 170 comprises a conventional lithographic photoresist or a laser ablatable resist. Unfortunately, conventional materials used for sacrificial layer 170 have a tendency to bum when impinged by laser output 130 suitable for laser rounding.

With reference to FIGS. 10b and 10c, it is preferable, therefore, to remove about a 10-25 μm wide area of sacrificial layer 170 from covering the ABS 24 in proximity to edges 66 or 82 to create a small uncovered zone 174. Uncovered zone 174 is preferably wider than the spot area of output 130 but narrow enough so that all ABS features 172 remain covered. These strips of sacrificial layer 170 can be removed by conventional lithographic techniques, or by direct ablation or expose and etch solid-state UV laser techniques disclosed in U.S. Pat. No. 6,025,256 of Swenson et al. An example of parameters for resist-processing laser output 176 includes a beam positioning offset 178 of 10-20 μm from edge 66 or 82, a 7 μm bite size, at 14 kHz at 30 μJ at 266 nm. If direct laser ablation is performed, the laser output parameters, particularly the power density, are adapted to be insufficient to adversely affect ABS 24. In a preferred embodiment, the same laser system 100 that is used to round edges 66 or 82 is used to remove the strip of sacrificial layer 170, but the laser output is generated at a higher repetition rate or the laser spot may be defocused to reduce the power density. FIG. 10c shows uncovered zone 174 after a strip of sacrificial layer 170 has been removed.

With reference to FIG. 10d, laser output 130 is applied to ABS 24 in uncovered zone 174. Laser output 130 is preferably positioned perpendicular to the ABS 24, with the spot centered at edges 66 or 82 (or corners 87), as shown; however, skilled persons will appreciate that other impingement angles and offsets from edges 66 or 82 can be employed. Although a single laser pass is preferable, multiple passes of laser output 130 can be employed. FIG. 10e shows redep 180a on the surface of sacrificial layer 170 and redep 180b on the surface of rounded edge 162 or 164, collectively redep 180, that may result from application of laser output 130.

After the laser rounding operation shown in FIG. 10d, a cleaning operation shown in FIG. 10f can be used to remove any laser-generated debris 180 that may have accumulated in the uncovered zone 174. A major advantage of employing a sacrificial layer is that it permits the use of more aggressive cleaning techniques, such as ion milling or reactive ion etching (RIE), to remove redep 180b without risk of damage to ABS features 172. These aggressive cleaning techniques may also remove a surface portion of sacrificial layer 170 and any redep 180a thereon. Without sacrificial layer 170, less aggressive cleaning techniques, such as solvent or surfactant applications with or without ultrasound or mechanical scrubbing, are preferred. FIG. 10g shows slider 10 after cleaning. Finally, sacrificial layer 170 is stripped off the entire ABS 24, removing any remaining laser-generated debris 180a with it. FIG. 10h shows an uncovered slider 150 or 160 with its sharp edge removed.

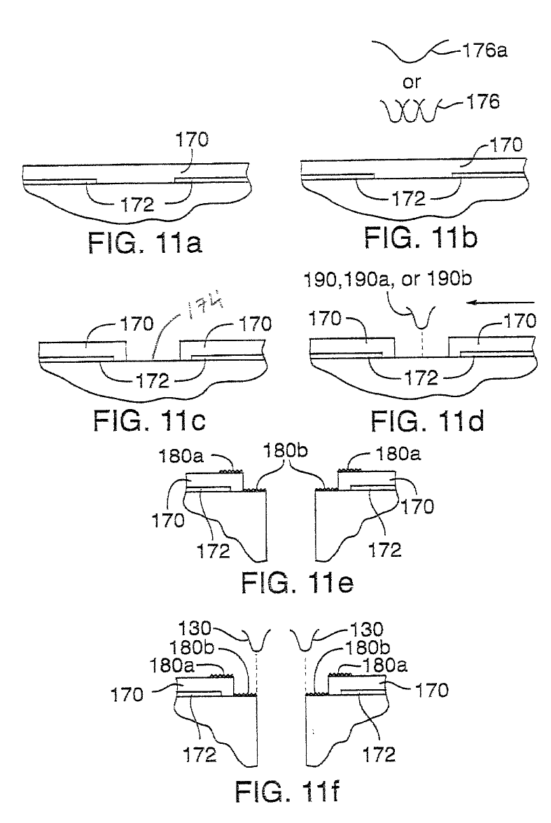

FIGS. 11a-11f (collectively FIG. 11) show simplified side sectional views of a generic workpiece as it undergoes process steps of an exemplary laser cutting process (row slicing or slider dicing). With reference to FIG. 11a, an optional sacrificial protection layer 170 may be applied to patterned ABS 24 or all of the workpiece surfaces, as previously described, prior to laser cutting. With respect to the overall process of manufacturing sliders 10, in one example, sacrificial layer 170 is applied directly after ABS 24 has been patterned and before the photoresist mask 72 has been removed. Alternatively, the rounding and/or severing processes can be performed using mask 72 before or after patterning. It can also alternatively be applied after mask 72 has been removed or after sliders 10 have been singulated. Instead of, or in addition to, covering the surface with sacrificial layer 170, laser cutting may be performed from the back side of wafer 50 so that laser-generated debris 180 becomes irrelevant. Back side alignment can be accomplished with laser or other markings or through holes made from ABS 24 side of wafer 50, and/or edge alignment and/or calibration with a camera view of ABS features 172 or deposited face of trailing end 12.

With reference to FIGS. 11b and 11c, preferably a 10-50 μm wide area of sacrificial layer 170 covering ABS 24 in proximity to intended edges 66 and 68 or 82 is removed to create an uncovered zone 174. These strips of sacrificial layer 170 can be removed as previously described. If appropriate for a specific layout of rows 60 or sliders 10, a larger spot size 176a or multiple adjacent or overlapping trim lines 140 of laser output 176 can be employed for ablative removal of a strip of sacrificial layer 170. FIG. 11c shows uncovered zone 174 after the strip of sacrificial layer 170 has been removed.

With reference to FIG. 11d, laser output 190 is applied to ABS 24 in uncovered zone 174. Laser output 190 is preferably positioned perpendicular to the ABS 24, with the spot centered between intended edges 66 and 68 or 82 (or on corners 85), as shown; however, skilled persons will appreciate that other impingement angles and offsets from intended edges 66 and 68 or 82 can be employed. Multiple passes of laser output 190 are typically employed for both row slicing and slider dicing; however, slider dicing can be achieved in a single pass. Laser output 190 used for laser cutting may employ a higher peak power density than laser output 130 used for laser rounding.

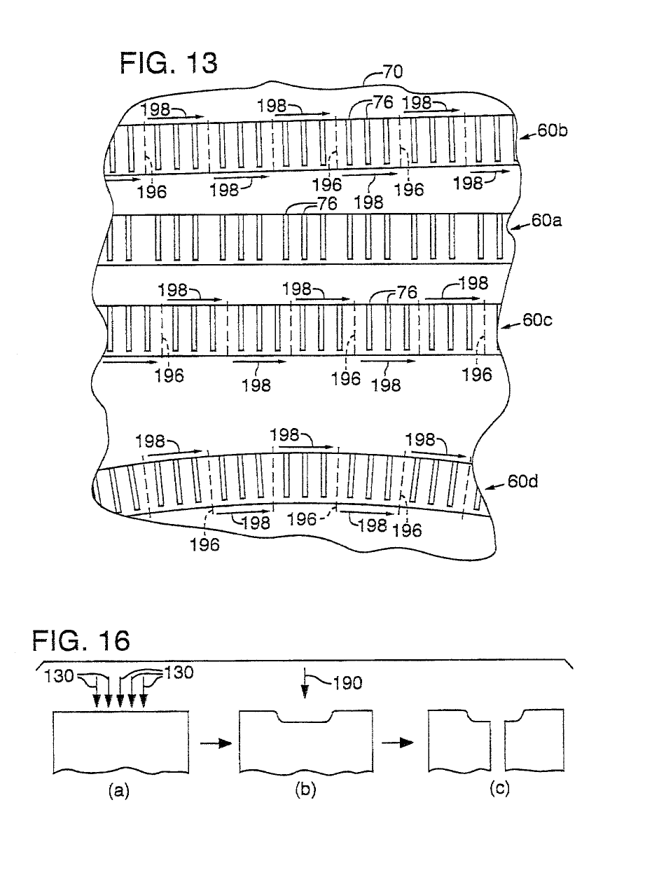

Although using common parameters for slicing through both the alumina and the AlTiC is advantageous for simplification, it may be desirable for throughput, for example, to employ different parameters for alumina slicing output 190a to slice through the alumina than for AlTiC slicing output 190b to slice through AlTiC. In particular, it may be desirable to use 266 nm or 355 nm to cut the alumina and 355 nm or 532 nm to cut the AlTiC. In one embodiment, row slicing through the alumina on multiple rows is performed with output 190a and then slicing through the AlTiC is performed in the notches with output 190b to finish the cuts. Alternatively, a row 60 may be sliced completely through with outputs 190a and 190b before a second row 60 is sliced. Each of the two different laser outputs 190 maybe applied in a single or in multiple passes. Switching the parameters of output 190 can be achieved with a single laser employing a switchable wavelength, repetition rate, or focus depth, or can be achieved through a multi laser head system, with different laser heads responsible for the different laser outputs 190. With respect to slider dicing, each traverse cut 196 (FIG. 13) traverses regions of slider 10 that are completely alumina and regions that are completely AlTiC. Accordingly, output 190a can be applied in one or more passes along the alumina portions of cuts 196 and then output 190b can be applied in one or more passes along the AlTiC portions of cuts 196. Alternatively, each cut 196 can be made completely one at a time, switching between alumina processing output 190a and AlTiC processing output 190b for each pass.

FIG. 11e shows separated edges 66, 68, or 82 with redep 180a on the surface of sacrificial layers 170 and redep 180b on the surface of edges 66, 68 or 82. FIG. 11f shows the beginning of the laser rounding process, described in connection with FIG. 10, that is applied to both edges 66 or 82. The debris 180 can optionally be cleaned off before the laser rounding process is performed to provide a flatter surface to facilitate rounding the edges to a preferred radius of curvature of about 20-25 μm Although laser cutting without the additional laser rounding step will provide benefits over mechanical cutting, performing a laser rounding step in addition to laser cutting is preferred.

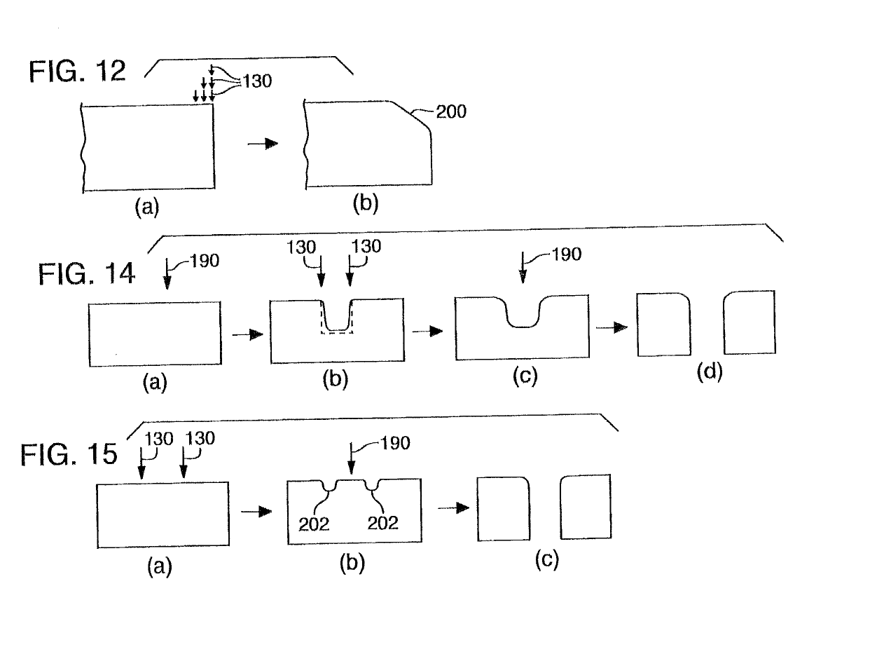

Applying one or more additional laser processing passes along the newly formed edges can change the radius of curvature along the edges. Furthermore, a more gradual slope can be obtained by employing one or a small number of passes slightly interior of an edge and gradually increasing the number of passes as the beam is positioned more closely to the edge. FIG. 12 shows a symbolic representation of forming such a gradually sloped edge 200 with the number of arrows in each column representing the number of passes. It is noted that an increased radius of curvature can also be achieved by performing one or multiple passes directly centered at the edge. Generally, the slope or angle of the edge or sidewall can be controlled by controlling the spacing of the lines of laser spots as well as the distances from the edge and number of passes. More passes at or near the edge results in a steeper angle, and passes further from the edge can be used to produce a shallower slope.

Although laser sacrificial layer strip removal, laser cutting, and laser rounding may entail multiple laser process steps at different parameters, an all laser process has many advantages and employs repositioning along only a single axis for each linear operation.

Laser cutting also destroys significantly less material (kerfs of less than 50 μm wide and preferably less than 25 μm wide) than does mechanical cutting (slicing lanes 62 of about 300 μm and dicing paths 78 of about 150 μm) so that sliders 10 can be manufactured much closer together, allowing many more sliders 10 to be produced on each wafer 50. Thus, the laser cutting process minimizes the pitch between rows and the pitch between sliders. In an example, the pitch between rows 60 can be 350 μm and the pitch between slider can be 1025 μm, realizing about a 33% increase in the number of rows 60 and a gain of about one slider 10 for every thirteen sliders 10 per row 60.

Elimination of the mechanical cutting can also simplify manufacture of sliders 10. In particular, mechanical cutting can impart significant mechanical stress to sliders 10 such that they come off carrier 70. To avoid losing rows, slider manufacturers typically employ strong adhesives or epoxies between rows 60 and carrier 70. An all laser process significantly reduces the mechanical strength requirements of the adhesive used for fixturing rows 60 onto carrier 70. Laser rounding and cutting, therefore, permits the elimination of strong adhesives or epoxies used to affix rows 60 to carrier 70 and the harsh chemicals needed to remove them. Instead, the adhesives can be selected for ease of debonding, such as the reduction of debond time and less exposure to potentially corrosive chemicals, and for amenability to UV laser processing, greatly reducing risk of damage to sliders 10, particularly ABS features 172, and thereby enhancing yield.

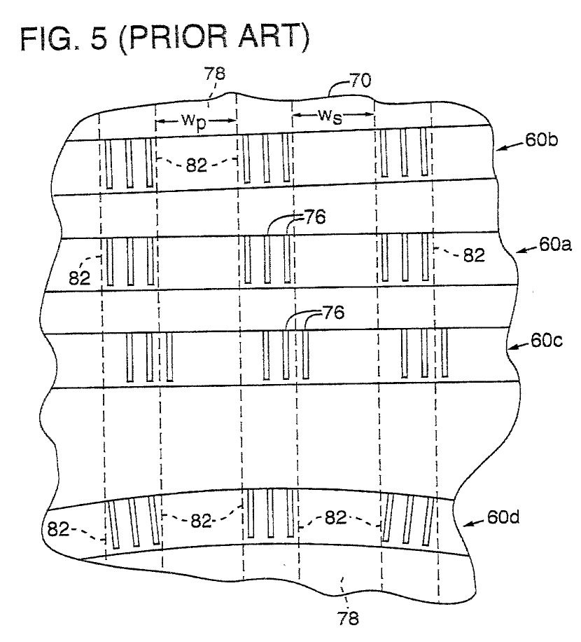

Laser row slicing reduces row bow because laser slicing does not exert as much mechanical stress as mechanical slicing. However, if row bow or other of the row defects shown in FIG. 5 are apparent, the rows 60 can be laser diced (and resliced) to compensate for these defects without concern for the critical slider to slider alignment needed between rows 60 for mechanical dicing.

FIG. 13 demonstrates an exemplary laser process for row defect compensation. Because positioning system 114 can align to edges 66, ABS features 172, and or fiducials, laser system 100 can process each row 60 and/or each slider 10 independently. With respect to slanted row 60b, the laser spot can perform traverse cuts 196 across row 60b at appropriate positions with respect to outer rails 76 with stage and/or beam translations 198 between each cut 196 to effect a square (or rectangular) wave pattern or to generally make cuts 196 at angles such that the surfaces of sliders 10 are substantially perpendicular to each other. Numerous other cutting patterns are possible such as making all cuts in a first column before making all cuts in second column. Sliders 10 in rows 60a and 60c can be singulated in a similar fashion regardless of angle or offset. With respect to row 60d, the rectangular wave cut and translate pattern can be curved to align with the row bow. Thus, so long as the mask pattern for ABS features 172 is properly aligned to pole tips 32 and 34, laser dicing can compensate for row fixturing defects and perhaps save entire rows 60 of sliders 10 that would be ruined by mechanical dicing. Skilled persons will appreciate that the spacing between sliders 10 in FIG. 13 is significantly smaller than wₚ permitted by prior art mechanical dicing demonstrated in FIG. 5.

FIG. 14 shows a flow diagram of a simplified cutting and rounding process with simplified side sectional views of a generic workpiece such as wafer 50 as it undergoes process steps. In this alternative embodiment, a mechanical cutting blade or laser output 190 notches rows 60 or sliders 10 along lanes 62 or paths 78 to a depth, preferably above an adhesive layer if a combination of laser and mechanical notching or cutting is to be employed. Alternatively, for preslice notching, laser output 190a may be employed to notch all the way through the alumina material. FIG. 14b shows the result of laser notching with a solid line and shows the result of mechanical notching with a broken line. Laser output 130 then rounds the desired edges and/or corners, and finally the mechanical cutting blade or laser output 190 finishes the separation of rows 60 or singulation of sliders 150 or 160. The width of the kerf or diameter used for the cutting process can be less than or equal to the width of the kerf or diameter used for the notching process. A sacrificial layer 170 and the related steps associated with it may be employed prior to a notching process. Skilled persons will appreciate that edges on the bottom side can optionally be done by this notching technique, preferably such that top and bottom alignment is conserved. Such notching would greatly facilitate subsequent laser separation of the rows 60 or sliders 10, 150, or 160. One advantage of this technique is that there are fewer pieces to align since the parts are still referenced to each other, i.e., the rounding is completed before the pieces are separated. Another advantage is that the preliminary notch does not expose the adhesive layer where mechanical cutting is to be employed, since the adhesives needed to withstand mechanical cutting are particularly volatile in response to laser radiation.

FIG. 15 shows a flow diagram of an alternative cutting and rounding process with simplified side sectional views of a generic workpiece as it undergoes process steps. With reference to FIGS. 7 and 15, rounding laser output 130 is applied along two parallel trim lines such as trim lines 140 in FIG. 7. The trim lines 140 are spaced such that the edges 82 of the dice lane 78 align with the centers of the trenches 202 produced by the laser outputs 130. In FIG. 15b, a dice blade or laser cuts the workpiece surface between the trenches 202 to produced rounded separate parts shown in FIG. 15c.

FIG. 16 shows an alternative rounding, notching, and separating process. In FIG. 16a, multiple adjacent passes of laser output 130 or 190 create an extra wide notch (FIG. 16b) with rounded edges. Then output 190 or a cutting blade is applied to separate the rows 60 or sliders 10. This process creates a shelfed edge shown in FIG. 16c. The edges of the lower shelves can be rounded with processes previously discussed.

With reference to FIGS. 11 and 13-16, it may be desirable to notch through one side of the workpiece, preferably about one half the thickness of the workpiece, and then finish the row or slider separation from the opposite side, preferably by flipping the workpiece and using alignment techniques previously discussed. This embodiment may provide significant throughput advantages particularly for high-aspect ratio kerfs. The rounding process can be performed before or after notching or after row or slider separation.

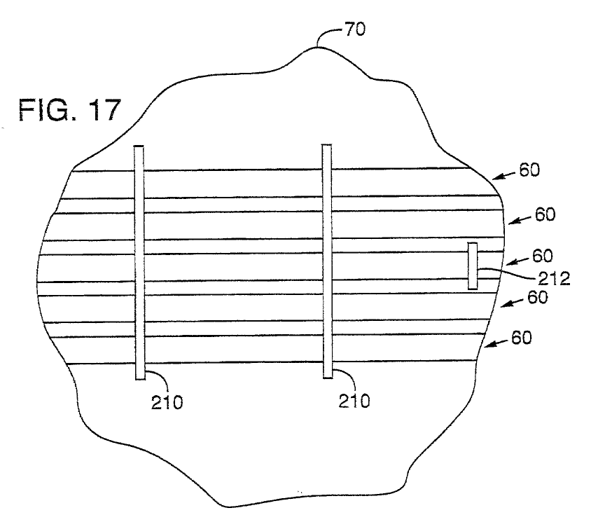

FIG. 17 demonstrates that an excimer laser at an appropriate UV wavelength can be used with appropriate-sized line-making masks 210 or 212 (about the width of preferred Gaussian spot sizes) for the above-described laser dicing or rounding operations without employing the preferred bite size technique. The line-making masks 210 or 212 can have a length the size of an entire column or as little as the desired edge. For example, the surfaces of wafers 50, rows 60, or sliders 10 can be covered with sacrificial layer 170; the portions of the sacrificial layer 170 can be removed to create uncovered zones; wafers 50 and/or rows 60 can be diced and edges 66, 68, 82, 84, and/or 86, and/or corners 85 and/or 87 can be rounded with a UV excimer through a line mask of an appropriate shape and size; the entire surface can be aggressively cleaned to remove debris from the uncovered zones; and the sacrificial layer can be removed.

Skilled persons will appreciate that if the slider industry moves toward making sliders on silicon wafers, the rounding and cutting processes disclosed herein can be applied to the silicon of such wafers. Silicon carbide and titanium carbide, which are ceramic alternatives to AlTiC, may also be similarly processed. Another preferred glass for processing is silicon dioxide.

It will be obvious to those having skill in the art that many changes may be made to the details of the above-described embodiments of this invention without departing from the underlying principles thereof. The scope of the present invention should, therefore, be determined only by the following claims.

1. A method for laser processing a slider having an edge formed from first and second transverse surfaces comprising:
generating first laser output having a wavelength shorter than or equal to about 355 nm;
directing the first laser output toward a first target location on the first surface in proximity to the edge of the slider such that a first spot area of first laser output impinges the first surface;
generating second laser output having a second spot area and a wavelength shorter than or equal to about 355 nm; and
directing the second laser output toward a second target location on the first surface in proximity to the edge of the slider, such that the second spot area impinges the first surface and such that the second spot area partly overlaps the first spot area and impinges a nonoverlapping area having a spatial major axis of 0.5-9 μm, thereby converting the edge to a rounded edge in proximity to the first and second target locations.

2. The method of claim 1 in which the nonoverlapping area comprises a spatial major axis of 1-7 μm.

3. The method of claim 1 in which the rounded edge comprises a radius of curvature of about 5-50 μm.

4. The method of claim 3 in which the rounded edge comprises a radius of curvature of about 5-25 μm.

5. The method of claim 1 in which the first and second laser outputs each have peak power of greater than 500 MW/cm².

6. The method of claim 1 in which the first and second spot areas each comprise a spatial major axis of about 5-25 μm.

7. The method of claim 1 in which the first and second laser outputs comprise an energy density of greater than about 50 J/cm² per pulse.

8. The method of claim 7 in which the first and second laser outputs comprise an energy density of about 200-1100 J/cm² per pulse.

9. The method of claim 1 further comprising:
delivering the first and second laser outputs at a repetition rate of greater than about 5 kHz.

10. The method of claim 9 further comprising:
delivering the first and second laser outputs at a repetition rate of about 5-10 kHz.

11. The method of claim 1 in which the first or second surfaces comprise an air-bearing surface of a magnetic head.

12. The method of claim 1 in which only a first portion of the first spot area impinges the first surface and only a second portion of the second spot area impinges the first surface.

13. The method of claim 12 in which the first and second spot areas have centers, and the centers of the spot areas are directed at the edge.

14. The method of claim 1 in which the slider has a slider depth transverse to the first or second surface, further comprising:
forming the edge to an edge depth that is less than the slider depth with a mechanical dicing blade prior to generating the first and second laser outputs.

15. The method of claim 14 further comprising:
extending the edge depth to equal the slider depth with a mechanical dicing blade subsequent to generating the first and second laser outputs.

16. The method of claim 1 in which the rounded edge has a radius of curvature, further comprising:
applying one or more adjacent or overlapping substantially parallel rows of first or second laser outputs to modify the radius of curvature of the rounded edge.

17. The method of claim 1 in which the rounded edge has a radius of curvature, further comprising:
applying one or more passes of one or more adjacent or overlapping substantially parallel rows of first or second laser outputs to modify the radius of curvature of the rounded edge.

18. The method of claim 1 in which the first or second laser outputs each comprise a single pulse, further comprising:
applying a single pass of successive partly overlapping first and second laser outputs to convert the edge into a rounded edge.

19. The method of claim 1 in which the surfaces comprise AlTiC or vacuum-deposited alumina.

20. The method of claim 1 in which the surfaces comprise silicon, silicon carbide, or titanium carbide.

21. A method for laser processing a brittle, high melting temperature ceramic, glass, or glass-like material, comprising:
generating first laser output having a wavelength shorter than or equal to about 355 nm;
directing the first laser output to impinge a first target location with a first spot area on a surface of a ceramic, glass, or glass-like target material, the laser output removing an amount of target material from the surface;
generating second laser output having a wavelength shorter than or equal to about 355 nm; and
directing the second laser output to impinge a second target location with a second spot area on the surface of the target material such that the second spot area partly overlaps the first spot area and impinges a nonoverlapping area having a spatial major axis of 0.5-9.5 μm, the laser output removing an amount of target material from the surface and generating debris that primarily comprises nonmolten materials such that redep, which comprises generated debris that contacts the surface, is nonpermanent and easily removable from the surface by conventional cleaning techniques.

22. The method of claim 21 further comprising:
cleaning the redep from the surface by mechanical scrubbing, solvent bathing, ultrasonic vibrating, ion milling, or reactive ion etching.

23. The method of claim 21 in which the first and second laser outputs comprise a peak power density of greater than about 500 MW/cm² per pulse.

24. The method of claim 23 further comprising:
delivering the first and second laser outputs at a repetition rate of greater than about 5 kHz.

25. The method of claim 24 in which the ceramic material comprises AlTiC, the glass material comprises silicon dioxide, or the glass-like material comprises vacuum-deposited alumina.

26. The method of claim 21 in which the target material resides along a length of a space between adjacent sliders, further comprising:
applying single or multiple passes of successive partly overlapping first and second spot areas along the length of the space between the adjacent sliders to separate the adjacent sliders.

27. The method of claim 26, further comprising:
applying a single pass of successive partly overlapping first and second laser outputs to edges formed between the adjacent sliders to convert the edges into rounded edges.

28. A method for laser processing a wafer containing multiple spaced-apart rows of multiple spaced-apart sliders comprising:
generating a first series of laser outputs having first spot areas and a wavelength shorter than or equal to about 355 nm;
directing the first series of laser outputs toward a first surface in a first space between a first row of sliders and a second row of sliders such that the first spot areas successively overlap and impinge a nonoverlapping area, on the first surface, having a spatial major axis of 0.01-9.5 μm;
generating a second series of laser outputs having second spot areas and a wavelength shorter than or equal to about 355 nm;
directing the second series of laser outputs toward the first surface in a second space between the second row of sliders and a third row of sliders such that the second spot areas successively overlap and impinge a nonoverlapping area, on the first surface, having a spatial major axis of 0.01-9.5 μm; and
generating and directing successive passes of first and second series of laser outputs until the second row of sliders is disconnected from the first and third rows of sliders.

29. The method of claim 28 in which the first and second spot areas each comprise a spatial major axis of about 5-15, in which the first and second laser outputs comprise a peak power density greater than about 500 MW/cm² per pulse, and in which the first and second laser outputs have a repetition rate of greater than about 5 kHz

30. The method of claim 28 in which the first and second surfaces are formed in proximity to each space and have pristine grain structure.

31. The method of claim 28 in which the surfaces comprise AlTiC or vacuum-deposited alumina.

32. The method of claim 28 in which the surfaces comprise silicon, silicon carbide, or titanium carbide.

33. A method for laser processing a row of multiple spaced-apart sliders comprising:
generating a first series of laser outputs having first spot areas and a wavelength shorter than or equal to about 355 nm;
directing the first series of laser outputs toward a first surface in a first space between a first slider and a second slider such that the first spot areas successively overlap and impinge a nonoverlapping area, on the first surface, having a spatial major axis of 1-7 μm;
generating a second series of laser outputs having second spot areas and a wavelength shorter than or equal to about 355 nm;
directing the second series of laser outputs toward the first surface in a second space between the second slider and a third slider such that the second spot areas successively overlap and impinge a nonoverlapping area, on the first surface, having a spatial major axis of 1-7 μm; and
generating and directing successive passes of first and second series of laser outputs until the second slider is disconnected from the first and third sliders.

34. The method of claim 33 in which the first and second spot areas each comprise a spatial major axis of about 5-15, in which the first and second laser outputs comprise an energy density greater than about 500 MW/cm² per pulse, and in which the first and second laser outputs have a repetition rate of greater than about 5 kHz.

35. The method of claim 34 in which the first and second surfaces are formed in proximity to each of the first and second spaces and have pristine grain structure.

36. The method of claim 33 in which the surfaces comprise AlTiC or vacuum-deposited alumina.

37. The method of claim 33 in which the surfaces comprise silicon, silicon carbide, or titanium carbide.

38. A method for laser processing a slider having an edge formed from first and second transverse surfaces comprising:
coating the first surface with a sacrificial layer;
removing a portion of the sacrificial layer in proximity to the sharp edge to create an uncovered zone;
employing a laser to impinge within the uncovered zone to convert the sharp edge to a rounded edge;
cleaning laser-generated debris from the uncovered zone; and
removing the sacrificial layer.

39. The method of claim 38 in which the laser is an excimer.

40. The method of claim 38 in which the laser is a Q-switched solid-state laser.

41. The method of claim 38 in which the sacrificial layer comprises photoresist.

42. The method of claim 38 in which cleaning comprises an aggressive cleaning technique.

43. The method of claim 38 in which the surfaces comprise AlTiC or vacuum-deposited alumina.

44. The method of claim 38 in which the surfaces comprise silicon, silicon carbide, or titanium carbide.

45. A method for laser processing sliders comprising:
coating the first surface with a sacrificial layer;
removing a portion of the sacrificial layer from the surface in a space between sliders to create an uncovered zone;
employing a laser or mechanical tool to impinge within the uncovered zone to create a pair of edges between the sliders;
employing a laser to impinge within the uncovered zone in proximity to the edges to convert the edges to rounded edges;
cleaning laser-generated debris from the uncovered zone; and
removing the sacrificial layer.

46. The method of claim 45 in which the laser is an excimer.

47. The method of claim 45 in which the laser is a Q-switched solid-state laser.

48. The method of claim 45 in which the sacrificial layer comprises photoresist.

49. The method of claim 45 in which cleaning comprises an aggressive cleaning technique.

50. The method of claim 45 in which the surfaces comprise AlTiC or vacuum-deposited alumina.

51. The method of claim 45 in which the surfaces comprise silicon, silicon carbide, or titanium carbide.

52. A method for laser processing a brittle, high melting temperature material with a laser spot having a substantially Gaussian irradiance profile wherein the laser spot has peak irradiance at its center and significantly less irradiance at its periphery, comprising:
generating first Gaussian laser output having a substantially Gaussian irradiance profile at wavelength shorter or equal to about 532 nm;
propagating a major portion of the first Gaussian laser output through an aperture to convert the first laser output into a first apertured output;
directing the first apertured output to impinge a first target location with a first spot area on a surface of a ceramic, glass, or glass-like target material, the first apertured output removing an amount of target material from the surface;
generating second Gaussian laser output having a substantially Gaussian irradiance profile at wavelength shorter or equal to about 532 nm;
propagating a major portion of the second Gaussian laser output through an aperture to convert the second laser output into a second apertured output; and
directing the second apertured output to impinge a second target location with a second spot area on the surface of the target material such that the second spot area partly overlaps the first spot area, the second apertured output removing an amount of target material from the surface and generating debris that primarily comprises nonmolten materials such that redep, which comprises generated debris that contacts the surface, is nonpermanent and easily removable from the surface by a conventional cleaning technique.

53. The method of claim 52 in which the cleaning technique comprises a nonagressive cleaning technique.

54. The method of claim 52 further comprising:
propagating the first and second Gaussian laser outputs along an optical path through a diffractive optical element to convert the first and second Gaussian laser outputs into a first and second more uniformly shaped outputs before propagating the major portions of them through the aperture.

55. The method of claim 54 further comprising:
propagating the first and second apertured shaped outputs through one or more imaging lens components to provide first and second imaged shaped outputs before directing them at the target locations.

56. The method of claim 55 in which the first and second imaged shaped outputs have respective first and second energy densities over the respective first and second spot areas, and the first and second energy densities are greater than a fluence below which permanent redep forms on the surface.

57. The method of claim 52 further comprising:
cleaning the redep from the surface by mechanical scrubbing, solvent bathing, ultrasonic vibrating, ion milling, or reaction ion etching.

58. The method of claim 52 in which the first and second apertured outputs comprise an energy density of greater than about 500 MW/cm² per pulse.

59. The method of claim 52 in which a nonoverlapping area of the first and second spot areas comprises a spatial major axis of 1-7 μm.

60. The method of claim 52 in which the first and second apertured outputs are applied in proximity to an edge of an air-bearing surface of a slider to round the edge.

61. The method of claim 52 in which the first and second spot areas each comprise a spatial major axis of about 5-15 μm.

62. The method of claim 52 further comprising:
delivering the first and second laser outputs at a repetition rate of greater than about 5 kHz.

63. The method of claim 52 in which the surfaces comprise AlTiC or vacuum-deposited alumina.

64. The method of claim 52 in which the surfaces comprise silicon, silicon carbide, or titanium carbide.

65. A method for singulating misaligned sliders from an array of sliders attached in rows on a carrier, comprising:
identifying a first feature on a first surface of a first slider row;
aligning with respect to the first feature on the first surface, a first target position of a laser system such that the target position is in proximity to a first intended edge of a first slider having surface features in a first orientation;
directing one or more laser outputs to impinge the first surface at the first target position and linearly therewith to form a first kerf that traverses the first slider row;
identifying a second feature on a second surface of a second slider row;
aligning with respect to the second feature on the second surface a second target position of the laser system such that the second target position is in proximity to a second intended edge of a second slider having surface features in a second orientation that is different from the first orientation; and
directing one or more laser outputs to impinge the second surface at the second target position and linearly therewith to form a second kerf that traverses the second slider row.

66. The method of claim 65 in which the first and second slider rows are the same slider row.

67. The method of claim 66 in which the slider row exhibits row bow.

68. The method of claim 66 in which the first and second laser outputs are sequential.

69. The method of claim 66 in which the first and second sliders are adjacent and the second laser output disconnects the first slider from the slider row.

70. The method of claim 65 in which the first and second sliders are in different rows.

71. The method of claim 70 in which the first and second laser outputs are sequential.

72. The method of claim 65 in which the first and/or second surface comprises AlTiC or vacuum-deposited alumina.

73. The method of claim 66 in which the surfaces comprise silicon, silicon carbide, or titanium carbide.

74. The method of claim 65 in which the first and second apertured outputs comprise an energy density of greater than about 500 MW/cm² per pulse.

75. The method of claim 65 in which the first and second spot areas each comprise a spatial major axis of about 5-15 μm.

76. The method of claim 65 in which a nonoverlapping area of the first and second spot areas comprises a spatial major axis of 1-7 μm.

77. The method of claim 65 in which the first and second surface features are analogous features of air-bearing surfaces of the first and second sliders.

78. The method of claim 65 in which the first and second orientations are askew with respect to each other.

79. The method of claim 65 in which the first and second slider rows are horizontally offset from each other.

80. A method for increasing the throughput of severing a workpiece having a workpiece depth and comprising a high melting temperature brittle material with a material depth of at least 300 μm comprising:
identifying a first feature on a first surface of the workpiece;
aligning with respect to the first feature on the first surface a first target position of a laser system such that the first target position is on the first surface and in proximity to a intended side of a component of the workpiece;
directing one or more first laser outputs to impinge the first surface at the first target position and linearly therewith to form a first kerf to a kerf depth that is less than the workpiece depth;
aligning with respect to a second feature on the first surface or on a second surface a second target position of the laser system such that the second target position is on a second surface and in proximity to the intended side of the component and in the same plane as the first target position; and
directing one or more second laser outputs to impinge the second surface at the second target position and linearly therewith to form a second kerf in the same plane as the first kerf to form a throughout that defines the intended side of the component.

81. The method of claim 81 in which first and second features comprise a through hole of arbitrary shape laser drilled through the workpiece depth and apparent on both the first and second surfaces.

82. The method of claim 80 in which the surfaces comprise AlTiC or vacuum-deposited alumina.

83. The method of claim 80 in which the surfaces comprise silicon, silicon carbide, or titanium carbide.

84. The method of claim 28 in which row bow is substantially reduced.

85. The method of claim 28 in which the first and second surfaces contains deposited ends of the sliders.

86. The method of claim 28 in which the first and second surfaces are on a first side opposite a second side containing deposited ends of the sliders.

87. The method of claim 33 in which the first and second surfaces contain airbearing surfaces.

88. The method of claim 33 in which the first and second surfaces are on a first side opposite a second side containing the airbearing surfaces.
